(19) United States
(12) Patent Application Publication
(10) Pub. No.: US 2015/0284911 A1
(43) Pub. Date: Oct. 8, 2015

(54) MOLDABLE FIBROUS PRODUCT AND METHOD OF PRODUCING THE SAME

(71) Applicant: TEKNOLOGIAN TUTKIMUSKESKUS VTT OY, Espoo (FI)

(72) Inventors: Marja Juvonen, Vtt (FI); Jaakko Hiltunen, Vtt (FI); Petri Jetsu, Jyvaskyla (FI); Marie Gestranius, Vtt (FI); Ali Harlin, Vtt (FI); Vesa Kunnari, Vtt (FI); Jouni Lattu, Vtt (FI); Karita Kinnunen, Vtt (FI); Tuomo Hjelt, Vtt (FI); Ilkka Nurminen, Vtt (FI); Erkki Saharainen, Vtt (FI); Henna Lampinen, Jyvaskyla (FI)

(21) Appl. No.: 14/646,744

(22) PCT Filed: Nov. 22, 2013
(86) PCT No.: PCT/FI2013/051097

§ 371 Date: May 22, 2015

(30) Foreign Application Priority Data
Nov. 22, 2012 (FI) 20126227

(51) Int. Cl. D21H 27/30; B32B 5/26; B32B 5/02; B32B 21/02; D21H 11/12; B32B 29/00; B32B 29/06; D21H 17/57; D21H 21/22; D06M 15/564; B32B 21/13

(52) U.S. Cl. CPC D21H 27/30; D06M 15/564; B32B 5/26; B32B 5/022; B32B 21/02; B32B 21/13; B32B 29/005; B32B 29/06; D21H 17/57; D21H 21/22; D21H 11/12; D06M 2101/06

(57) ABSTRACT

A moldable fibrous product, includes foam-formed fibrous material selected from fibrous webs, paper webs, board webs, or sheets cut from any of the webs, at least one polymer selected from carbohydrate derivatives, polylactic acid, polyurethane and polyolefins impregnated in the web, and from 0.001 to 0.1% by weight of at least one foaming agent.

### FIELD OF THE INVENTION

The present invention relates to moldable fibrous products, to a method for the manufacture of moldable fibrous products and to the use of said moldable fibrous products for the manufacture of molded fibrous articles. Accordingly, a moldable fibrous product, such as moldable pulp material, a paper web or a cardboard web or a paper sheet or a cardboard sheet or the like may be obtained.

### BACKGROUND OF THE INVENTION

The utilization of fibers, particularly wood fibers, in the manufacture of moldable packages is limited because fiber based webs are generally considered lacking moldability properties. In many cases also translucency would be appreciated in such materials.

Moldable fibrous products, such as moldable pulp materials are typically used as package materials for small packages including egg cases, small machine tool packages, seedling raising pots, packages for small electronic devices etc. A molded product formed of such a moldable pulp material is manufactured by applying moldable pulp slurry produced typically from waste paper, such as newspaper to a porous mold or a mold with a mesh screen, and then dehydrating, pressing, and drying the applied layer of moldable pulp slurry in several stages. These molded products have a relatively small thickness, low strength, and they are not firm enough to hold heavy objects. Further, they have a relatively small shock absorbing capability.

U.S. Pat. No. 5,785,817 A describes a method of manufacturing a molded pulp product, comprising the steps of mixing a moldable pulp material comprising a main constituent of pulp, a starch binder, and thermally expandable hollow particles with water which is effective to gelatinize the starch binder, filling the moldable pulp material mixed with the water in a mold assembly and compressing the moldable pulp material in the mold assembly, and heating the compressed moldable pulp material to at least a gelatinization temperature at which the starch binder is gelatinized, for thereby gelatinizing the starch binder to produce a molded pulp product of the moldable pulp material.

Several further methods and agents, such as enzymes have been proposed in the art for modifying the properties, such as moldability of fibrous products, particularly of fibrous webs. A moist web may be stretched and shaped more easily than dry webs, however typically the strength of the products is low and surface properties inferior.

FI 20061049 describes a method for the manufacture of moldable fibrous webs, where the fibrous web is impregnated with a dispersion or solution of a chemically modified polymer, such as starch derivatives, polymeric lignin derivatives etc.

Thermoformed plastic materials are widely used for packaging purposes, particularly in modified atmosphere packaging applications. In the packaging of pharmaceutical products blister packages made of PVC and aluminum foil are utilized, however these cannot be incinerated and they are no biodegradable. Composite products made of fibers and plastics have also been proposed, having high plastic content.

WO2010/046534 relates to a fibrous product, which has at least one transparent or translucent area that comprises a carbohydrate derivative, which is plasticized with a plasticizer. Said carbohydrate derivative may be long-chained carbohydrate, such as starch, dextrin, cellulose, hemicellulose, cellulose acetate, starch acetate and corresponding polymers. It is also possible to use other carbohydrate derivative-like thermoplastic biopolymers, such as polylactic acid.

GB 1 012 120 relates to a method where watermark-like transparent areas are formed by impregnating the paper with different chemicals, such as sucrose acetate isobutyrate.

In JP 2665566, the transparency of paper is improved by applying onto its surface paraffin, a higher fatty acid or a fatty acid alcohol ester or a similar material, which is diluted in a solvent, such as benzene, toluene or xylene, or in chlorinated hydrocarbon or in alcohol.

There are substantial disadvantages associated with the moldable products according to the state of the art. Many of them contain high amounts of various chemicals, the products are not sufficiently homogenous, their strength and or surface properties are inferior.

The purpose of the present invention is thus to eliminate at least part of the disadvantages associated with the known technology and to provide a completely new solution for moldable or moldable and translucent fibrous products and their manufacture.

### OBJECT OF THE INVENTION

An object of the invention is to provide moldable fibrous products.

Another object of the invention is to provide moldable and translucent fibrous products.

A still further object of the invention is a method for the manufacture of moldable fibrous products.

A still further object of the invention is a method for the manufacture of moldable and translucent fibrous products.

A still further object of the invention is to provide molded fibrous products.

A still further object of the invention is to provide molded and translucent fibrous products.

### DEFINITIONS

Unless otherwise specified, the terms, which are used in the specification and claims, have the meanings commonly used in the field of paper, board, cardboard and tissue industry, particularly in the field of paper and pulp chemistry and industry. Specifically, the following terms have the meanings indicated below.

The term “fibrous material” refers here to fibrous web, fibrous sheet, fibrous mat or blanket comprising fibers.

The term “moldable fibrous product” refers here to fibrous material, which can be molded to desired shape, size and form, with the aid of heat and or humidity.

The term “molded fibrous product” refers here to products obtained from moldable fibrous products after molding.

The term “translucent product” refers here to a product, which permits light to pass through, but the object on the opposite side are not clearly visible. Light is transmitted through, but diffusion prevents perception of distinct images.

With the term “translucent” is meant that a symbol which is situated under the product or the surface (on the other side in relation to the viewer), such as text or FIGURE or color or similar marking, is visible or readable or otherwise optically detectable through the modified area of the fibrous product. In general, the present invention aims at essentially changing or controlling, or both, the permeability of visible light and of UV and IR radiation. Thus, the term “translucent” refers to products which have been prepared to be either “transparent” or “translucent”.

The expression “foam-formed fibrous material” refers here to fibrous material, as defined above, which is obtained from a foam-formation process.

### SUMMARY OF THE INVENTION

The present invention is based on the idea that foam-formed fibrous material is impregnated with at least one polymer to obtain a moldable fibrous product, which can further be molded to a product of pre-designed form and dimensions.

By this impregnation treatment the foam-formed fibrous material is transformed to a moldable fibrous product having improved elongation properties at elevated temperatures and/or in the presence of humidity. The moldable fibrous product is particularly suitable for thermoformation, for providing molded products of predetermined shape and size.

### FIGURES

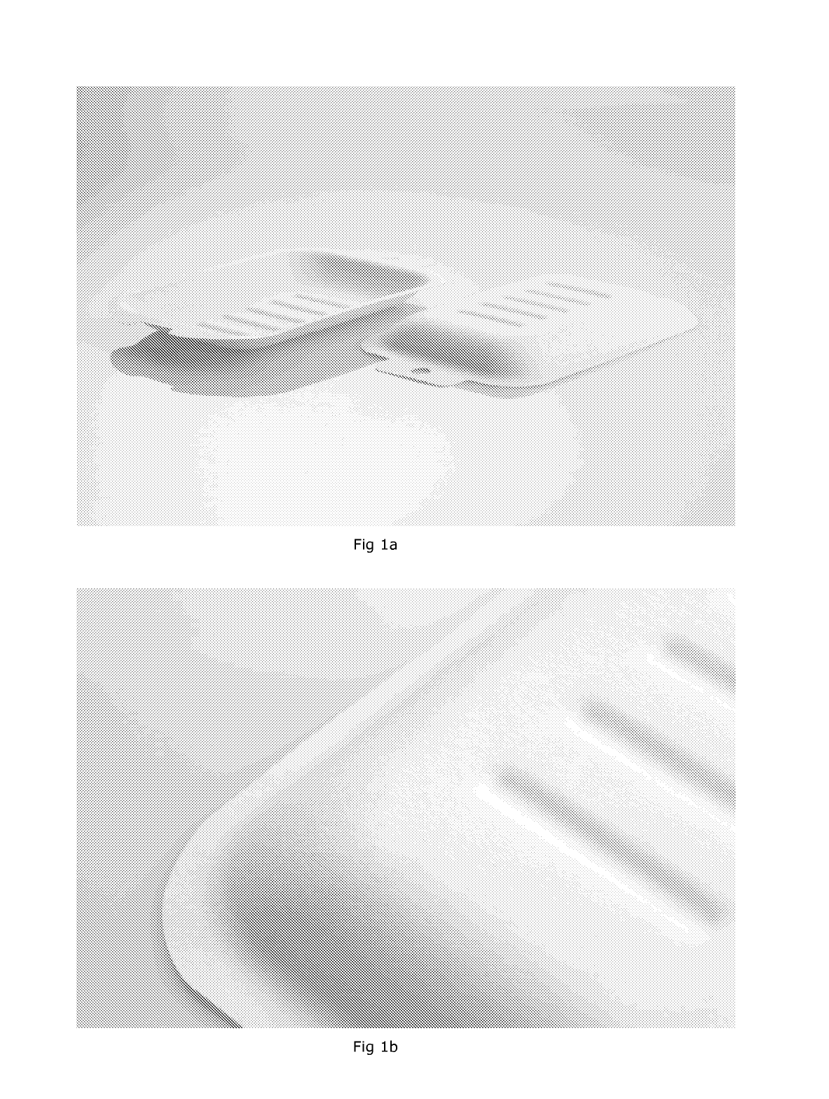

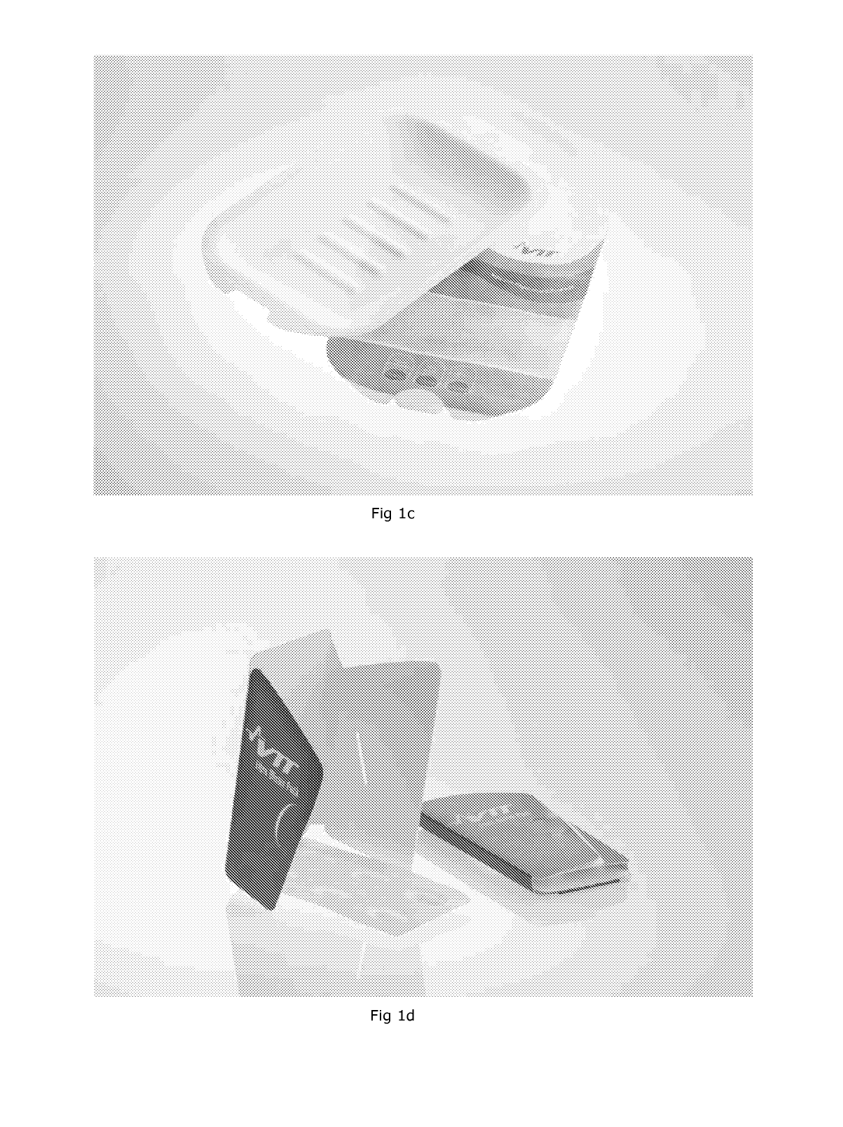

Packages made of foam-formed impregnated board web are presented in FIG. 1 (a-d).

### DETAILED DESCRIPTION OF THE INVENTION

It was surprisingly found that a moldable, strong and durable fibrous product can be obtained, which may easily be molded to molded fibrous products having predesigned shape, form and size, suitably to three-dimensional products. Said molded fibrous products may find use in various applications in the fields of packaging, advertising, composite materials, interior design, furniture, etc.

### Moldable Fibrous Product

The moldable fibrous product comprises foam-formed fibrous material. Said fibrous material may be selected from fibrous webs, mats, blankets, paper webs, board webs, tissue webs, or sheets cut from any of said webs. Said fibrous material may be formed from plant derived (natural fibers) or synthetic fibers, or any combinations thereof. Natural (plant derived) fibers may be selected from chemical pulp, such as sulphate and sulphite pulp, organosolv pulp, recycled fibers, and/or mechanical pulp including e.g. refiner mechanical pulp (RMP), pressurized refiner mechanical pulp (PRMP), pretreatment refiner chemical alkaline peroxide mechanical pulp (P-RC APMP), thermomechanical pulp (TMP), thermomechanical chemical pulp (TMCP), high-temperature TMP (HT-TMP) RTS-TMP, alkaline peroxide pulp (APP), alkaline peroxide mechanical pulp (APMP), alkaline peroxide thermomechanical pulp (APTMP), Thermopulp, groundwood pulp (GW), stone groundwood pulp (SGW), pressure groundwood pulp (PGW), super pressure groundwood pulp (PGW-S), thermo groundwood pulp (TGW), thermo stone groundwood pulp (TSGW), chemimechanical pulp (CMP), chemirefinermechanical pulp (CRMP), chemithermomechanical pulp (CTMP), high-temperature CTMP (HT-CTMP), sulphite-modified thermomechanical pulp (SMTMP), reject CTMP (CTMPR), groundwood CTMP (G-CTMP), semichemical pulp (SC), neutral sulphite semi chemical pulp (NSSC), high-yield sulphite pulp (HYS), biomechanical pulp (BRMP), pulps produced according to the OPCO process, explosion pulping process, Bi-Vis process, dilution water sulfonation process (DWS), sulfonated long fibres process (SLF), chemically treated long fibres process (CTLF), long fibre CMP process (LFCMP), Kraft wood pulp, mdf-fibers, nanocellulose, cellulose fibers having average particle size less than 1000 nm, and modifications and combinations thereof. The pulp may be a bleached or non-bleached pulp. The pulp may originate from hardwood or softwood, including birch, beech, aspen such as European aspen, alder, eucalyptus, maple, acacia, mixed tropical hardwood, pine such as loblolly pine, fir, hemlock, larch, spruce such as Black spruce or Norway spruce, recycled pulp, waste streams and side streams comprising fibers and originating from food and pulp and paper industry, and any mixtures thereof.

Also non-wood plant raw material, such as seed hair fibers, leaf fibers, bast fibers, plant fibers can be provided from e.g. straws of grain crops, wheat straw, reed canary grass, reeds, flax, hemp, kenaf, jute, ramie, seed, sisal, abaca, coir, bamboo, bagasse, cotton kapok, milkweed, pineapple, cotton, rice, reed, esparto grass, Phalaris arundinacea, or combinations thereof may be used.

The synthetic fibers may comprise fibers of polyester, polyethylene, polypropylene, polylactide, rayon, lyocell, nylon, glass, polyacetate, aramide, carbon and any combinations thereof.

Additionally, optional additives may be used. Said additives may for example comprise wetting agents, wet-strengtheners, coloring agents, fire protection agents (e.g. borates, phosphates, magnesium trihydrate), softening agents, inorganic fillers and any combinations thereof.

Preferably fibers comprising unground long fiber materials are used, as well as recycled fibers.

According to one preferable embodiment said fibers comprise unground softwood pulp and 10-50% by weight of finely ground hardwood pulp or cellulose having average particle size less than 1000 nm.

Typical characteristics of the foam-formed fibrous material are a significant proportion of large pores and/or presence of traces of foaming agent. The foam formed structures typically contain at least 1% proportion of large pores whose diameter is greater than 2.4 times the average pore diameter. Here the diameters are defined by filling the pores with spheres of maximal size. The amount of foaming agent ranges from 0.0001-0.1 weight percent in said moldable fibrous product.

Said moldable fibrous product comprises at least one polymer selected from carbohydrate derivatives, polylactic acid, polyurethane and polyolefins. Examples of suitable carbohydrate derivatives are cellulose derivatives, starch and dextrin derivatives and mixtures of two or more derivatives. Examples of such derivatives are: cellulose C1-4 alkyl ester, oxidized cellulose C1-4 alkyl ester, starch C1-4 alkyl ester, oxidized starch C1-4 lower alkyl ester, and corresponding ethers and mixtures of esters and/or ethers. Suitable derivatives are cellulose and starch esters and ethers, especially lower alkyl esters, such as methyl, ethyl, propyl and butyl esters (cellulose or starch formate, -acetate, -propionate and -butyrate). Preferably said polymer is selected from polyurethane, polyethene and cellulose esters.

The amount of the polymer in the moldable fibrous product is from 1 to 65% by weight, calculated from the dry product, preferably from 10 to 50% by weight and particularly preferably from 20 to 40% by weight.

The moldable fibrous product may optionally comprise at least one plasticizer, which is hydrophilic or hydrophobic or both. The plasticizer improves the compatibility of the polymer with the fibers, particularly cellulose fibers, and affects the viscoelastic behavior of the fibers at the softening and melting temperatures of the polymer, whereby the moldability, such as thermoformation of the moldable fibrous product is improved, and the separation of the polymer from the fibers can be avoided.

Suitably said plasticizer is selected from mono-, di- and triglyceric ester of acetic acid, C2-4 alcohols comprising 1-5 hydroxyl groups, and esters of these, mono-, di- or trialkyl esters of citric acid, particularly mono-, di- or tri-C1-4-alkyl esters of citric acid, propylene glycol, dipropylene glycol, glycerol and mixtures thereof, and mixtures thereof. Preferably, a biodegradable plasticizer is used. According to a preferable embodiment of the present invention, the plasticizing material is triethyl citrate, glycerol or glycerol monoacetate, which is non-toxic, non-volatile water-soluble liquid.

The amount of the plasticizer is from 10 to 30% by weight of the amount of the polymer, calculated by dry weight.

Said moldable fibrous product may comprise at least one layer or it may be a multilayer product comprising more than one layers. The layered structure may also comprise a polymeric layer between layers of fibrous material, and said polymer layer or film may act as a barrier. Suitably polyethene and the like may be used as barrier materials or barrier layers.

The moldable fibrous product may comprise from 0.1 to 74% by weight of fibers.

According to one embodiment the moldable fibrous product is porous, with other words air containing light weight material with density of 10-250 kg/m³.

Suitable the grammage of each layer in the multilayer product is 40-500 g/m², preferably from 50 to 200 g/m², particularly preferably from 80 to 150 g/m².

A translucent and moldable product may also be manufactured.

### Method for the Manufacture of the Moldable Fibrous Product

The method for the manufacture of the moldable fibrous product comprises the steps of:
forming at least one foamed dispersion by dispersing fibers in a foamable liquid comprising water and at least one foaming agent,
conveying the foamed dispersion or dispersions to a foraminous support and draining liquid trough the foraminous support to form a web or a sheet, and
impregnating at least part of the web or sheet with a liquid comprising at least one polymer to obtain the moldable fibrous product.

Optionally drying is carried out after the impregnation step.

The web or sheet is optionally dried prior to the impregnation step to attain water content of suitably less than 60% by weight.

Optionally at least one additional foamed dispersion is formed of fibers selected from natural fibers and synthetic fibers, by dispersing said fibers material in a foamable liquid comprising water and at least one foaming agent. Optionally said foamed dispersions are conveyed to the foraminous support as individual layers, followed by draining, impregnating and optional drying steps as instructed above.

Said fibers may comprise plant derived (natural fibers) or synthetic fibers, or any combinations thereof. Natural (plant derived) fibers may be selected from chemical pulp, such as sulphate and sulphite pulp, organosolv pulp, recycled fibers, and/or mechanical pulp including e.g. refiner mechanical pulp (RMP), pressurized refiner mechanical pulp (PRMP), pretreatment refiner chemical alkaline peroxide mechanical pulp (P-RC APMP), thermomechanical pulp (TMP), thermomechanical chemical pulp (TMCP), high-temperature TMP (HT-TMP) RTS-TMP, alkaline peroxide pulp (APP), alkaline peroxide mechanical pulp (APMP), alkaline peroxide thermomechanical pulp (APTMP), Thermopulp, groundwood pulp (GW), stone groundwood pulp (SGW), pressure groundwood pulp (PGW), super pressure groundwood pulp (PGW-S), thermo groundwood pulp (TGW), thermo stone groundwood pulp (TSGW), chemimechanical pulp (CMP), chemirefinermechanical pulp (CRMP), chemithermomechanical pulp (CTMP), high-temperature CTMP (HT-CTMP), sulphite-modified thermomechanical pulp (SMTMP), reject CTMP (CTMPR), groundwood CTMP (G-CTMP), semichemical pulp (SC), neutral sulphite semi chemical pulp (NSSC), high-yield sulphite pulp (HYS), biomechanical pulp (BRMP), pulps produced according to the OPCO process, explosion pulping process, Bi-Vis process, dilution water sulfonation process (DWS), sulfonated long fibres process (SLF), chemically treated long fibres process (CTLF), long fibre CMP process (LFCMP), Kraft wood pulp, mdf-fibers, nanocellulose, cellulose fibers having average particle size less than 1000 nm, and modifications and combinations thereof. The pulp may be a bleached or non-bleached pulp. The pulp may originate from hardwood or softwood, including birch, beech, aspen such as European aspen, alder, eucalyptus, maple, acacia, mixed tropical hardwood, pine such as loblolly pine, fir, hemlock, larch, spruce such as Black spruce or Norway spruce, recycled pulp, waste streams and side streams comprising fibers and originating from food and pulp and paper industry, and any mixtures thereof.

Also non-wood plant raw material, such as seed hair fibers, leaf fibers, bast fibers, plant fibers can be provided from e.g. straws of grain crops, wheat straw, reed canary grass, reeds, flax, hemp, kenaf, jute, ramie, seed, sisal, abaca, coir, bamboo, bagasse, cotton kapok, milkweed, pineapple, cotton, rice, reed, esparto grass, Phalaris arundinacea, or combinations thereof may be used.

The synthetic fibers may comprise fibers of polyester, polyethylene, polypropylene, polylactide, rayon, lyocell, nylon, glass, polyacetate, aramide, carbon and any combinations thereof.

Additionally, optional additives may be used. Said additives may comprise wetting agents, wet-strengtheners, coloring agents, fire protection agents (e.g. borates, phosphates, magnesium trihydrate), softening agents, inorganic fillers and any combinations thereof.

Preferably fibers comprising unground long fiber materials are used, as well as recycled fibers.

According to a preferable embodiment said fibers comprise unground softwood pulp and 10-50% by weight of finely ground hardwood pulp or cellulose having average particle size less than 1000 nm.

The foraminous support is suitable a wire.

The draining is suitably carried out with the aid of vacuum, using vacuum pumps, or by gravitational filtration.

Drying of the formed web or sheet is suitably carried out by any suitable means, for example by heating with means conventionally used in the manufacture of non-woven, paper and tissue products.

In the method the foamed dispersion (or dispersions) is formed of 0.1-20% by weight, preferably 0.5-15% by weight, particularly preferably 1-10% by weight of fibers selected from natural fibers, synthetic fibers and combinations thereof, of 0.005-5% by weight, preferably 0.01-2% by weight, particularly preferably 0.01-1% by weight of at least one foaming agent, water and optional binders, and optional additives.

The additional foamed dispersion(s) is conveyed individually on the support, whereby a product comprising at least two individual fiber layers is obtained.

The foamed dispersion comprises from 55 to 75% by volume, preferably from 60 to 70% by volume of air. Air refers here to all gases having more than 50% by volume of nitrogen content, which includes atmospheric air or gases derived from atmospheric air.

The liquid comprising at least one polymer refers to melted liquid polymer, or an aqueous dispersion comprising polymer particles dispersed therein, or to a suspension comprising polymer particles suspended therein. Said dispersion or suspension may comprise 20-50, preferably 30-40% wt of the polymer.

Said polymer is preferably selected from polyurethane, polyethene and cellulose acetate.

The impregnation of the fibrous web or sheet may be carried out by pressing, using spray coating, roller, extrusion coating, curtain coating, foam coating, through tanks containing the impregnation solution, flexo printing, screen printing, transfer film techniques or other such techniques, on one side or on both sides. Optionally elevated temperature (20-250° C.) and pressure (0.1-20 Mpa) or vacuum may be used. In pressing a polymer film is pressed to the surface of the fibrous web or sheet at an elevated temperature, whereby said polymer melts into a liquid. The impregnation may suitably be followed by passing through any of pressing, calendering, glazing, drying and winding stations.

The plasticizer may be applied on the web or sheet after impregnation with the polymer, using methods descried above in connection with the impregnation step.

The average particle size of the polymer in a dispersion or suspension is preferably from 0.5 to 800 nm, preferably from 1 to 600 nm. The average particle size may be measured using methods known in the art, suitably with Coulter-Counter. The use of the specific particle size improves the impregnation rate and provides good thermoforming properties to the product. Products with higher elongation properties at elevated temperatures are obtained, having improved moldability properties during for example thermoformation. Said foam-formed fiber material contains pores and cavities. Thus particularly polymers having smaller average particle size have better access to the cavities than the ones with larger particle size and provide improved and more homogeneous impregnation. On the contrary, larger particles may clog the pores and cavities and obstruct smaller particles entering, whereby the poor impregnation, typically remaining on the surface only is obtained.

Optionally at least one plasticizer is mixed with the polymer melt or polymer dispersion or polymer suspension, or alternatively said plasticizer is applied on the web or sheet after impregnation with the polymer, using methods descried above in connection with the impregnation step.

Suitably said plasticizer is selected from mono-, di- and triglyceric ester of acetic acid, C2-4 alcohols comprising 1-5 hydroxyl groups, and esters of these, mono-, di- or trialkyl esters of citric acid, particularly mono-, di- or tri-C1-4-alkyl esters of citric acid, propylene glycol, dipropylene glycol, glycerol and mixtures thereof, and mixtures thereof, suitably in the form of aqueous solutions or blended with polymer liquid. Preferably, a biodegradable plasticizer is used.

According to a preferable embodiment of the present invention, the plasticizing material is triethyl citrate, glycerol or glycerol monoacetate, which is non-toxic, non-volatile water-soluble liquid.

The amount of the plasticizer is from 10-30% by weight of the amount of the polymer, calculated by dry weight.

The foaming agent may act as a surface active agent, enabling the foam formation and additionally it may act as a binder in the formed structure.

The foaming agent is selected from anionic, cationic, non-ionic and amphoteric surface active agents and surfactants, proteins, and any combination thereof, including polyvinyl alcohol and foamable starches. Suitably said foaming agent is selected from anionic and non-ionic surface active agents, polyvinyl alcohols and foamable starches.

Optionally traditional additives, such as binders may be used.

In the foam-laid method any equipment and apparatus used in foam-formation processes in the tissue paper and non-woven manufacture can be utilized here, such as suggested for example in GB 1397378, EP 481746 and U.S. Pat. No. 3,716,449. Products comprising one or more foam-deposited layers may be obtained.

Foam-formation technique helps to reduce the amount of needed water and energy in the process, and makes it possible to use a completely closed process. Said moldable fibrous product may comprise one layer of fibrous material (single-layer product) or more than one layer of fibrous material, and one or more layers comprising thermoplastic compounds. The layers may be combined by lamination, with adhesives, barrier layers and the like whereby a multi-layered structure is obtained.

The method may optionally further comprise coating step, whereby coating methods known in the art may be carried out using coating dispersions.

The moldable fibrous product may be subjected steps selected from cutting, undulating, thermoforming or molding in a molding device, with the aid of heat and optionally moisture, to obtain products with predetermined form and size.

Considerable advantages can be achieved with the present invention. Foam-formed fibrous material can be impregnated through the product with higher amounts of the polymer or polymer-plasticizer blend, whereby easily moldable and according to some embodiments translucent products may be achieved, for providing strong molded products with appealing surface properties and finishing.

Thus, by impregnating a foam-formed fibrous material, it is possible to manufacture moldable fibrous products which can be processed to various molded products. Said molded products may be used as packages for fragile and delicate products, for food packages, consumer packages, for blister packages of pharmaceuticals and other products requiring such packages, as wood plastic composites in automotive industry, transportation and building industry, interior design, and furniture industry.

In addition, the embodiment using biodegradable plastics in said moldable fibrous products makes it easier to recycle those packages.

Particularly foam-formation results in a very porous structure in the fibrous web or sheet, suitably comprising longer fibers. This strength and elongation properties of this structure are improved by one or more of the following: incorporating finely ground fibers therein, by impregnation with a polymer, selecting a suitable particle size of the polymer and by using a plasticizer. The porous structure can be homogeneously impregnated.

Accordingly, the adhesion of cellulose fibers with the polymer may further be improved with selected plasticizer, particularly in the molding stage, whereby the separation of fibers from polymeric material can be avoided.

Also packages with local or complete translucency can be obtained if desired. Impregnation of the surface or dosing of the liquid polymer onto the surface of the paper, onto an area of a desired size, by means of an orifice or a roller, followed by a compressing stage.

The invention provides a moldable and optionally translucent single-layer or multilayer fibrous product, with improved elongation properties at elevated temperatures. It was surprising that the moldable fibrous products can be very easily molded or thermoformed into desired shape and size, to yield product with high strength properties, appealing finishing, and additionally good barrier properties and translucency if needed.

The product can easily be molded for example using moisture and/or heat to a desired form or structure. The molding of the moldable fibrous product is suitably carried out at elevated temperatures, without moisture, where by heat activates the polymer incorporated in the product and enables easy molding and further the transparency of the product is maintained, at least up to 10 mm thickness. This can surprisingly be achieved also with multi-layer structures containing more than 2 layers. Alternatively, molding may also be carried out in the presence of moisture at elevated temperatures typically below 100° C.

An important advantage is also that the product may be winded on a roll, which makes it possible to use the product in high-speed packaging lines where the molding is carried out just prior packaging utilizing “form-fill-seal” technique.

The product may be used for replacing packaging materials based on non-renewable sources, such as plastics widely used in food and pharmaceutical industry. The product may be molded to trays suitable for packaging of food, such as meat products, it may be used for form-and-seal packages, in modified atmosphere packages, in blister packages for replacing plastic and aluminum foil blisters.

The present invention can be used to produce foodstuff packages, consumer packages, transport packages, and products which include FIGURES formed of translucent areas. Also sufficiently strong moldable fibrous products are provided for producing molded packaging materials for larger and heavier pieces.

The following illustrating examples do not restrict the scope of protection of the present invention.

### EXAMPLES

### Example 1

### Packages

Packages presented in FIG. 1 (a-d) were manufactured as follows:

Dried foam-formed fiber web (board), manufactured from non-ground non-pressed pine pulp, was impregnated (250 g/m²) with a polyurethane (PU) dispersion having dry matter content of 35% by weight. PU-dispersion was spread using k-coater on one side of the web, which was then subjected to pressing in a press, the other side of the web was coated with the PU-dispersion and pressed, followed by placing the web in an oven at 80° C. temperature for 5 minutes. Then the obtained impregnated product was attached to a mold and placed in an oven at 80° C. temperature for 10 minutes, followed by pressing the product in the mold to desired form. Excess drying was prevented during the method.

Impregnation may be carried out using any method described in the specification. The press may be replaced with external pressure, rolls etc.

1. A moldable fibrous product comprising foam-formed fibrous material selected from fibrous webs, paper webs, board webs, or sheets cut from any of said webs, at least one polymer selected from carbohydrate derivatives, polylactic acid, polyurethane and polyolefins impregnated in the web, and from 0.001 to 0.1% by weight of at least one foaming agent.

2. The moldable fibrous product according to claim 1, wherein the fibrous material comprises plant derived or synthetic fibers, or any combinations thereof.

3. The moldable fibrous product according to claim 1, wherein the fibrous material comprises 10-50% by weight of finely ground hardwood pulp or cellulose having average particle size less than 1000 nm.

4. The moldable fibrous product according to claim 1, further comprising at least one plasticizer selected from mono-, di- and triglyceric ester of acetic acid, C2-4 alcohols comprising 1-5 hydroxyl groups, and esters of these, mono-, di- or trialkyl esters of citric acid and combinations thereof.

5. The moldable fibrous product according to claim 1, wherein the polymer is polyurethane.

6. The moldable fibrous product according to claim 1, wherein the fibrous product is a multilayer product comprising more than one layer.

7. The moldable fibrous product according to claim 6, wherein the multi-layer product comprises at least one barrier layer between two fiber layers.

8. The moldable fibrous product according to claim 1, wherein the product is transparent.

9. A method for the manufacture of a moldable fibrous product, which comprises the steps of forming at least one foamed dispersion by dispersing fibers in a foamable liquid comprising water and at least one foaming agent, conveying the foamed dispersion or dispersions to a foraminous support and draining liquid trough the foraminous support to form a web or a sheet, whereby the draining is carried out with the aid of vacuum or by gravitational filtration, and impregnating at least part of the web or sheet with a liquid comprising at least one polymer to obtain the moldable fibrous product.

10. The method according to claim 9, wherein the fibers comprise plant derived or synthetic fibers, or any combinations thereof.

11. The method according to claim 9, wherein the fibers comprise 10-50% by weight of finely ground hardwood pulp or cellulose having average particle size less than 1000 nm.

12. The method according to claim 9, wherein the liquid comprising the polymers comprises at least one plasticizer selected from mono-, di- and triglyceric ester of acetic acid, C2-4 alcohols comprising 1-5 hydroxyl groups, and esters of these, mono-, di- or trialkyl esters of citric acid and combinations thereof.

13. The method according to claim 9, wherein the amount of the plasticizer is 10-30% of the weight of the polymer.

14. The method according to claim 9, wherein the liquid comprising at least one polymer is a melt, aqueous suspension or aqueous dispersion.

15. The method according to claim 14, wherein the average particle size of a polymer in the dispersion or suspension is from 0.5 to 800 nm, preferably from 1 to 600 nm.

16. The method according to claim 9, wherein the impregnated product is dried.

17. The method according to claim 9, wherein at least one additional foamed dispersion is formed of fibrous by dispersing said fibrous material in a foamable liquid comprising water and at least one foaming agent, and conveyed on the support as an individual layer, whereby a product comprising at least two individual fiber layers is obtained.

18. The moldable fibrous product according to claim 2, wherein the fibrous material comprises 10-50% by weight of finely ground hardwood pulp or cellulose having an average particle size of less than 1000 nm.

19. The method according to claim 10, wherein the fibers comprise 10-50% by weight of finely ground hardwood pulp or cellulose having an average particle size of less than 1000 nm.
